(19) United States
(12) Patent Application Publication
(10) Pub. No.: US 2019/0375180 A1
(43) Pub. Date: Dec. 12, 2019

(54) A MULTI-LAYERED PIPE AND A USE OF A MULTI-LAYERED PIPE

(71) Applicant: Wavin B.V., Zwolle (NL)

(72) Inventors: Marinus Peter Kremer, Hardenberg (NL); Yogesh Sheshrao Deshmukh, Dedemsvaart (NL); Marco Goris, Hardenberg (NL); Johannes Akkerman, Haulerwijk (NL)

(73) Assignee: Wavin B.V., Zwolle (NL)

(21) Appl. No.: 16/462,442

(22) PCT Filed: Nov. 29, 2017
(86) PCT No.: PCT/EP2017/080841

§ 371 Date: May 20, 2019

(30) Foreign Application Priority Data
Nov. 29, 2016 (NL) 1042164

(51) Int. Cl. B32B 1/08; B32B 27/08

(52) U.S. Cl. CPC B32B 1/08; B32B 27/32; B32B 27/08

(57) ABSTRACT

A multi-layered pipe having a wall with a protective outer layer which comprises PET, wherein preferably the protective outer layer is the most outer layer of the pipe, wherein preferably at least one of the layers is pigmented, and wherein preferably at least one of the layers is transparent, wherein the pipe further has a barrier layer which has relative to polyolefin an enhanced resistance to permeation therethrough of at least one of: hydrocarbon molecules, oxygen molecules, hydrogen molecules.

The disclosure relates to a multi-layered pipe as well as to a method for manufacturing the same. In particular, the disclosure relates to a multi-layered pipe to be used for transportation of drinking water.

Such pipes may need to be laid in contaminated ground (e.g. contaminated with oil, coal tar, petroleum, etc., that is, contaminated up to an extent that as yet no cleaning of the ground is required). For such a situation, there is a need to prevent ingress of hydrocarbon molecules through the wall of the pipe into the water supply.

EP 0638749 A1 proposed to use in the pipe wall a barrier layer made of polymers which have a very low permeability to hydrocarbons and to gases. The barrier layer is proposed as an outer layer onto an inner layer of polyolefin. One of these layers, or both, are disclosed to have adhesive polymer units derived from unsaturated epoxy or acyl compounds incorporated therein, in at least a region of an interface between the layers. The adhesive polymer units are present in a concentration effective to bond the polyolefin layer to the barrier layer.

A problem is that during laying a pipe scratches may be formed on the pipe, damaging the outer layer. For that reason the most outer layer is often not the barrier layer but an additional so-called protective layer.

It is an object of the present invention to provide an alternative pipe for transporting drinking water through contaminated ground, ideally addressing at least one of the problems of the prior art.

According to an aspect of the present disclosure, it is an object to provide a pipe for transporting drinking water through contaminated ground, ideally addressing undesired complexity of prior art pipes. Such complexity may be presented by the number of layers of the pipe.

According to this aspect of the present disclosure, the additionally presented invention provides for a multi-layer pipe having a wall with a protective outer layer which comprises PET. Such a protective layer has a relatively high resistance to scratch-formation, particularly relative to PE, PP or PVC. Preferably, the protective outer layer is the most outer layer of the pipe. A most outer layer comprising PET, or even better made of PET, ensures that the most outer wall of the pipe has a relatively low coefficient of friction and has a resistance to formation of scratches. PET has a low coefficient of friction, for instance as compared to PE, PP and PVC. This allows for use of such a pipe for “trenchlessly” laying a pipe, sometimes also referred to as “no-dig” applications. In such applications, no trench is dug for laying the pie in, and covering the pipe with sandsoil, but a drill advances through the ground under a surface thereof and pulls as such a pipe (often rolling off from a drum) through the channel drilled by the drill. In such an application the low friction of the most outer PET layer is very useful, as it also allows for more efficient use of the drill.

An outer layer comprising PET and a most outer layer comprising PET each have the advantage that it allows for a combination of a protective layer and a barrier layer, as will further be discussed below. Preferably, it also applies to embodiments of the additionally presented invention, that the pipe further has a barrier layer formed of a non-metallic barrier material, which barrier material has relative to polyolefin an enhanced resistance to permeation therethrough of hydrocarbon molecules, and preferably also an enhanced resistance, relative to polyolefin, to permeation therethrough of oxygen molecules and/or hydrogen molecules.

Preferably the enhanced resistance to permeation of hydrocarbon molecules applies to permeation from the outside to the inside, i.e. radially inwardly. Preferably, the enhanced resistance to permeation of oxygen and/or hydrogen applies to permeation from the inside to the outside, i.e. radially outwardly. The latter allows for instance for the use as a fuel supply pipe.

In embodiments of the additionally presented invention, the barrier layer may thus also comprise PET.

Where in this aspect of the present disclosure reference is made to “comprising”, it also embraces “made of”. Having the protective most outer layer of PET and the barrier layer of PET reduces complexity of the multi-layer pipe.

Preferably, at least one of the layers is pigmented, allowing for colour coding. Preferably, at least one of the layers is transparent allowing for observing (as seen from a position radially outside the pipe) the colour of the next layer.

Different appearances of layers also allows for assessing different thicknesses in a cross-sectional view of the wall of the pipe, that is locking at an end of a pipe, in axial direction.

In an embodiment of the disclosure, the protective layer has a thickness which is in the range of 0.1 mm to 0.7 mm. Further, preferably, the barrier layer has a thickness which is in a range of 0.1 to 0.8 mm.

In a very preferred embodiment, the protective layer and the barrier layer are together incorporated in a single layer. Preferably, the single layer has a thickness in a range of 0.2 to 1.5 mm.

The disclosure further relates to a method of forming a multi-layer pipe and to uses of a multi-layered pipe.

Embodiments of the invention and advantages thereof are further presented and discussed with reference to the drawing showing in:

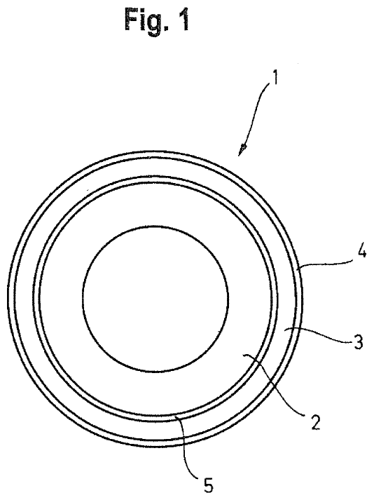

FIG. 1: in cross-section a first embodiment of a pipe according to an embodiment of the invention; and

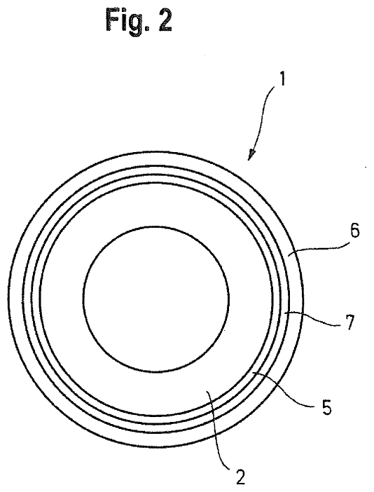

FIG. 2: in cross-section a first embodiment of a pipe according to the additionally presented invention;

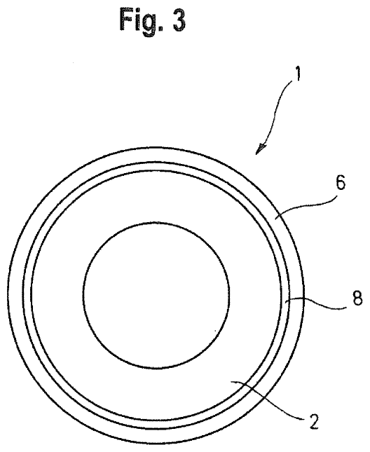

FIG. 3: in cross-section a second embodiment of a pipe according to the additionally presented invention.

In the drawing, like parts have like references. FIG. 1 shows schematically in cross-section a multi-layered pipe 1 comprising a wall having a polyolefin inner layer 2 and, in this example, a barrier layer 3 being an outer layer relative to the polyolefin layer 2. The barrier layer 3 is preferably formed of a non-metallic barrier material, which has relative to polyolefin an enhanced resistance to diffusion therethrough of hydrocarbon molecules. Such hydrocarbon molecules may include relatively small hydrocarbon molecules, and more particularly may include toluene trichloroethylene and P-dichlorobenzene. Preferably, the barrier layer also has, relative to polyolefin, resistance to permeation of hydrogen gas. Possibly, the pipe can then be used for transport of natural gas, respectively hydrogen gas. Preferably the barrier layer also has, relative to polyolefin, resistance to permeation of relatively “pure” oxygen gas. Possibly the pipe can then be used for transport of oxygen gas. Although it is preferred that an outer layer and/or the most outer layer is of PET, that is not necessarily the case.

The pipe 1 further preferably comprises a protective layer 4 being an outer layer 5 relative to the barrier layer 3. Preferably, the outer layer is the most outer layer. The protective layer and the barrier layer may together be incorporated in a single layer. It is advantageous when the protective layer and the barrier layer are of the same material. No tie layer is then needed between these layers. The two layers can be applied as a single layer.

The pipe further preferably comprises a peelable layer 5 between the polyolefin inner layer 2 and the barrier layer 3.

The peelable layer is formable around the polyolefin inner layer, for instance by means of extrusion. Further down this description, another method of forming such a multi-layer pipe will be discussed.

For joining pipes, particularly when inner core pipe material is of a polyolefin, it is important that during the welding the composition of the melt is the same as the composition of the inner core pipes which are to be joined. If the composition of the melt is different, then the joins will be inferior, possibly leading to a weakness, within or of the join, if not leading to a failure of the join. Pipe parts which are to be joined are preferably also free from dirt and/or oxidation, particularly when electrofusion fitting is used for joining the pipes. For this reason, the outer layers, i.e. the layers outside the inner core layer of polyolefin, are removed before welding, for instance, by electrofusion, takes place.

The peelable layer 5 is sufficiently “bonded” to the polyolefin inner layer 2 to prevent relative movement between the peelable layer 5 and the inner layer 2. Such relative movement is prevented from occurring, particularly during normal use of the pipe, including transporting, laying and subjecting the pipe in the ground to “ground forces” as may statically and/or dynamically be exerted onto the pipe, possibly from different directions. Such normal use of the pipe does not include a deliberately attempting to remove the peelable layer 5 and any layers being outer layers relative to the peelable layer 5, by means of peeling.

The peelable layer is insufficiently bonded to prevent the peelable layer and therewith any layers being outer layers relative to the peelable layer, from removal by peeling. The peelable layer 5 may be adhering to the polyolefin inner layer, but most preferably no use is made of adhesives. Preferably, no chemical bonding is in place. Preferably, no material or adhesive is present between the peelable layer and the polyolefin inner layer.

The adhesive strength between the outer layers, i.e. all the layers other than the polyolefin inner layer 2, is preferably such that the force required to rupture the set of outer layers, is greater than the force required to peel the peelable layer 5 from the polyolefin inner layer 2. Removal of the peelable layer 5 and therewith any layers being outer layers relative to the peelable layer 5, by means of peeling, leaves a preferably clean outer surface of the polyolefin inner layer 2.

In this context, a clean surface is meant to be a pipe surface that can be subjected to welding and/or electrofusion jointing without further preparation or treatment. Such surfaces should be clean such the electrofusion joint formed meets the requirements of one or more of PREN12201 Part 3, PREN1555 Part 3 and WIS 04-32-14.

Peelability is a measurable property of a layer. Reference is made to, for instance, WO 2004/016976 A1, particularly Appendix 1 thereof. Peelability is usually assessed by determining the adhesion strength, using a rolling drum peel test as described on page 15 and 16 of this document. In short, using a knife, a cut is made from the most outer layer through subsequent layers up to and including the peelable layer 5. A strip of about 25 mm wide, i.e. 25 mm in longitudinal direction of the pipe, and about 30-40 mm in length is peeled off whilst remaining attached to the pipe. The free end of that strip is then clamped in jaws of a tensile testing machine. The peelable layer 5 and the outer layers relative to the peelable layer 5 are then peeled from the pipe at a separation rate of 100 mm/minute. The force needed is measured as a function of time. When the adhesion force as measured in such a way is between 0.1 and 0.8 newton/mm, then the layers to be peeled off are said to have a good peelability. The assessment of the adhesion force may be based on a number of tests, and applying straightforward stabilizing.

Good peelability means that the layers can be removed in the field manually and using a knife by removal of the peelable layer 5 (and therewith the outer layers relative to the peelable layer 5) as is required for welding the pipe ends together, either heads on, or by means of an additional pipe part that overlaps the pipe ends to be joined.

The welding and electrofusion techniques are well-known in the art.

The peelable layer 5 may comprise one of polyethylene (PE), polypropylene (PP), polycarbonate (PC), polystyrene (PS), polyamide (PA), polyvinylchloride (PVC), polybutylene (PB). Preferably, the peelable layer 5 comprises a propylene copolymer, preferably a propylene block copolymer. This material is suitable for extrusion. Frequently used PP grade has an MFR of approximately 0.3 gr/10 min and an Emod of 1300 MPa, i.e. good properties for its function.

The peelable layer 5 may comprise an adhesive for bonding the respective peelable layer against the barrier layer 3. If the peelable layer is too thin, it is more difficult to peel the external layer. The peelable layer 5 may have a thickness which is equal to or more than 0.4 mm, and more preferably equal to or more than 0.7 mm.

The polyolefin inner layer 2 is preferably of polyethylene (PE). PE is widely used for drinkwater pressure application.

The barrier layer 3 is ideally free from EVOH and/or free from polyamide (PA), as these are too hydrophilic. Permeation is often seen to consist of three processes, namely 1) absorption of the permeating molecules (in gaseous or vaporous state) into the material (here into the polymer); 2) diffusion through the polymer; and 3) description of the permeating molecules from the polymer surface. A quantity that provides measurable characteristics of the permeation is the permeation coefficient, which is defined as the diffusion coefficient multiplied by the partition coefficient (the latter quantity being a measure of the solubility of small molecules in a polymer). Ideally, the barrier layer 3 comprises plastic material that has at 20° C. a permeability coefficient equal to or smaller than 1×10⁻¹⁵ m².s⁻¹. Preferably, the barrier layer 3 comprises at least one of polyethylene terephthalate (PET), amorphous polyethylene terephthalate (APET), PET (crystalline PET), polybutylene terephthalate (PBT), polyethylene naphthalate (PEN) and/or polyethylene furanoate (PEF). The barrier layer 3 may have a thickness which is equal to or more than 0.4 mm, preferably equal to or more than 0.6 mm, even more preferably equal to or more than 0.8 mm. A thicker barrier layer will provide a longer path for molecules to reach the other side of the layer, and therefore better barrier properties. A barrier layer comprising PET may have a thickness which is in a range of 0.1 mm to 0.8 mm.

The protective layer 4 may comprise at least one of polyethylene (PE), polypropylene (PP), polycarbonate (PC), polystyrene (PS), polyamide (PA), polyvinylchloride (PVC), polybutylene (PB). The protective layer 4 may have a thickness which is equal to or more than 0.4 mm, more preferably equal to or more than 0.7 mm. A thick layer provides more certainty that damaging the barrier layer will be avoided. The protective layer 4 may comprise an adhesive for bonding the protective layer 5 against the barrier layer 3. Alternatively, or additionally, between the protective layer 5 and the barrier layer 3 a tie layer of the first type (not shown) may be situated for bonding the protective layer 5 against the barrier layer 3. Such a tie layer of the first type may have a thickness of about 0.1 mm. The tie layer of the first type may be composed of maleic anhydride grafted polymer.

The protective layer most preferably comprises PET and may then have a thickness in a range of 0.1 mm to 0.7 mm. If the barrier layer equally comprises PET, then the protective layer and the barrier layer may together be incorporated in a single layer. The single layer may then have a thickness in the range of 0.2 to 1.5 mm.

Between the peelable layer 5 and the barrier layer 3 a tie layer of a second type (not shown) may be situated for bonding the peelable layer 5 against the barrier layer 3. The tie layer of the second type may equally have a thickness of about 0.1 mm. The tie layer of the second type may be composed of maleic anhydride grafted polymer.

Clearly, a multilayer pipe may comprise 4, 5 or 6 layers which are each of a different material as compared to the material of each directly adjacently situated layer. Preferably the multilayer pipe has been formed by coextrusion of its layers. The polymeric materials may be brought together in a pressure area of an extrusion die and exit as a single extrudable. For example, the extrusion die may be connected to 1, 2, 3 or more extruders and fed with separate streams of multimaterial. Alternatively, the die may be provided with concentric die outlets fed with separate streams of multipolymeric materials which are to form the inner core and the various outer layers. In this technique, the extrudables on leaving the extruder die outlets, can be brought into contact with each other while still molten, preferably in a sizing die which simultaneously adjusts the outer diameters of the pipe.

In an alternative, the inner core extrudable, in this case of polyolefin, may be passed through a sizing die before applying the peelable layer and further outer layers. In this case it may be necessary to reheat or flame burst the surface of the inner core extradite to create a surface ready to receive the peelable layer and the various outer layers. Because of the difficulty of maintaining a consistent adhesion between the inner polyolefin layer and the peelable layer and further outer layers, and of keeping the outer surface of the polyolefin inner layer clean (prior to applying the peelable layer and the further outer layers), this method is not presently preferred.

FIG. 2 shows schematically in cross-section a multi-layered pipe 1 having as a most outer layer a protective layer which comprises PET. The multi-layered pipe 1 also has a barrier layer, which equally comprises PET. The protective layer and the barrier layer are together incorporated in a single layer 6. Between the single layer 6 and the peelable layer 5, in this example of PB, there is a tie layer 7.

FIG. 3 shows schematically in cross section a multi-layered pipe 1 having a single layer 6, a peelable tie layer 8 and a polyolefin inner layer.

1. A multi-layered pipe having a wall with a protective outer layer which comprises PET.

2. The multi-layered pipe, according to claim 1, wherein the protective outer layer is the most outer layer of the pipe.

3. The multi-layered pipe, according to claim 1, wherein at least one of the layers is pigmented.

4. The multi-layered pipe according to claim 3, wherein at least one of the layers is transparent.

5. The multi-layered pipe according to claim 1, further having a barrier layer which has relative to polyolefin an enhanced resistance to permeation therethrough of at least one of: hydrocarbon molecules, oxygen molecules, hydrogen molecules.

6. The multi-layered pipe according to claim 5, where the barrier layer is non-metallic.

7. The multi-layered pipe according to claim 6, wherein the barrier layer comprises PET.

8. The multi-layered pipe according to claim 1, wherein the protective layer has a thickness which is in a range of 0.1 mm to 0.7 mm.

9. The multi-layered pipe according to claim 1, wherein the barrier layer has a thickness which is in a range of 0.1 mm to 0.8 mm.

10. The multi-layered pipe according to claim 1, wherein the protective layer and the barrier layer are together incorporated in a single layer.

11. The multi-layered pipe according to claim 10, wherein the single layer has a thickness in the range of 0.2 mm to 1.5 mm.

12. The multi-layered pipe according to claim 1, wherein the pipe has a polyolefin most inner layer.

13. The multi-layered pipe according to claim 5, wherein the pipe further comprises a peelable layer between the polyolefin most inner layer and the barrier layer.

14. The multi-layered pipe according to claim 13, wherein the peelable layer is formable around the polyolefin inner layer by means of extrusion.

15. The multi-layered pipe according to claim 13, wherein the peelable layer is a peelable tie layer of PE.

16. The multi-layered pipe according to claim 5, wherein between the protective layer and the barrier layer a tie layer of a first type is situated for bonding the protective layer against the barrier layer.

17. The multi-layered pipe according to claim 5, wherein between the peelable layer and the barrier layer a tie layer of a second type is situated for bonding the peelable layer against the barrier layer.

18. The multi-layered pipe according to claim 12, wherein the tie layer of the first type and/or of the second type has a thickness of about 0.1 mm.

19. The multi-layered pipe according to claim 5, wherein the barrier layer is free from EVOH and or free from polyamide (PA).

20. The multi-layered pipe according to claim 5, wherein the barrier layer comprises a plastic material that has at 20° C. a permeation coefficient equal to or smaller than 1×10⁻¹⁵ m².s⁻¹

21. The multi-layered pipe according to claim 5, wherein the barrier layer comprises at least one of polyethylene terephthalate (PET), amorphous polyethylene terephthalate (APET), polybutylene terephthalate (PBT), polyethylene naphthalate (PEN) and polyethylene furanoate (PEF).

22. The multi-layered pipe according to claim 13, wherein the peelable layer comprises at least one of polyethylene (PE), polypropylene (PP), polycarbonate (PC), polystyrene (PS), polyamide (PA), polyvinylchloride (PVC), polybutylene (PB).

23. The multi-layered pipe according to claim 1, wherein the multi-layered pipe has been formed by co-extrusion of its layers.

24. The multi-layered pipe according to claim 1, wherein the multilayer pipe comprises 3, 4, 5 or 6 layers which are each of a different material as compared to the material of each directly adjacently situated layer.

25. The multi-layered pipe according to claim 1, wherein the peelable layer has a thickness which is equal to or more than 0.1 mm, preferably equal to or more than 0.4 mm, even more preferably equal to or more than 0.7 mm.

26. The multi-layered pipe according to claim 1, wherein the most inner layer is of polyethylene (PE).

27. The multi-layered pipe according to claim 1, wherein the peelable layer is sufficiently bonded to the inner layer to prevent relative movement between the peelable layer and the inner layer, and is insufficiently bonded to prevent removal of the peelable layer and therewith any layers being outer layers relative to the peelable layer, from removal by peeling.

28. The multi-layered pipe according to claim 1, wherein the peelable layer is at least at the side facing the polyolefin inner layer free from any adhesives.

29. The multi-layered pipe according to claim 1, wherein no material or adhesive is present between the peelable layer and the polyolefin inner layer.

30. The multi-layered pipe according to claim 1, wherein the peelable layer comprises a propylene co-polymer, preferably a propylene block co-polymer.

31. The multi-layered pipe according to claim 1, wherein the protective outer layer is a loose layer forming a sleeve that can slide over the most adjacent radially inwardly positioned layer.

32. A method for forming a multi-layered pipe comprising co-extruding a protective outer layer which comprises PET with a second layer.

33. The method according to claims 32, wherein the method comprises co-extruding the protective outer layer with the second layer through at least one die.

34. The method according to claim 32, wherein the method comprises co-extruding the protective outer layer with the second layer through a first die producing two layers and a second die oriented under an angle with respect to the two layers produced by the first die.

35. The method according to claim 32, wherein the method comprises co-extruding the protective outer layer with the second layer through a first die producing two layers and a number of second dies which are each oriented under an angle with respect to the two layers produced by the first die.

36. The multi-layered pipe according to claim 1, wherein the pipe is constructed and arranged to be laid trenchlessly.

37. The multi-layered pipe according to claim 5, wherein the pipe is constructed and arranged to transport therethrough of one of oxygen gas and hydrogen gas.
